(19) United States
(12) Patent Application Publication
(10) Pub. No.: US 2026/0312054 A1
(43) Pub. Date: Oct. 8, 2026

(54) PREPARATION OF A CATHODE PRIMING COAT

(71) Applicant: COATEX, Genay (FR)

(72) Inventors: Benoît MAGNY, Fontaines Saint Martin (FR); Guillaume MICHAUD, Lyon (FR); Gaël ROBIN, Sathonay-Camp (FR); Jean-Marc SUAU, Lucenay (FR)

(73) Assignee: COATEX, Genay (FR)

(21) Appl. No.: 19/480,056

(22) PCT Filed: Apr. 16, 2024
(86) PCT No.: PCT/FR2024/000050

§ 371 Date: Oct. 30, 2025

(30) Foreign Application Priority Data
May 4, 2023 (FR) FR2304465

(51) Int. Cl. H01M 4/62; H01M 4/02; H01M 4/04

(52) U.S. Cl. CPC H01M 4/622; H01M 4/0404; H01M 4/0435; H01M 4/625; H01M 2004/028

(57) ABSTRACT

A process may prepare a cathode priming coat including combining two polyacrylic binders having different molecular weights and carbon particles. A composition may be suitable for such a process and a cathode containing such a composition can be used for manufacturing cells for a rechargeable battery. Such a composition may include a binding agent Q including a water-soluble polymer P1, with a molecular mass Mw of more than 100,000 to 1,000,000 g/mol, measured by SEC, including, in polymerized form, (a1) (meth)acrylic acid, (meth)acrylic acid oligomer, (meth)acrylic acid salt, and/or (meth)acrylic acid oligomer salt; a binding agent R including a water-soluble polymer P2, with a molecular mass Mw of 2,000 to less than 100,000 g/mol, measured by SEC, including, in polymerized form, (a2) (meth)acrylic acid, (meth)acrylic acid oligomer, (meth)acrylic acid salt, and/or (meth)acrylic acid oligomer salt; and a material E including carbon particles

The invention relates to a method for preparing a cathode primer coating combining two polyacrylic binding agents with different molecular masses and carbon particles. The invention also relates to a composition suitable for this method and to a cathode that can be used for producing cells for secondary batteries.

There are known cathode preparation compositions that generally comprise carbon and a metal in the form of particles combined with a binding composition. Binding compositions make it possible to set the particles on a metallic substrate. The binding property is therefore decisive when manufacturing a cathode using these compositions.

The time and yield required to manufacture cathodes are also important factors. It is therefore important to improve the efficacy of the various reactions involved.

As ingredients that are electrochemically inactive during cathode operation, binding compounds do not contribute directly to the capacity of the battery cell comprising the cathode, but their influence on the overall electrochemical performance remains considerable. These binding compounds should help form stable networks of the active or conducting solid compounds present in the cathodes.

The binding compounds used when preparing a cathode should also make it possible to improve thermal stability, chemical and electrochemical stability and tensile strength, in particular through good adhesion and cohesion, as well as a certain degree of flexibility.

Moreover, the compatibility of the various ingredients of the cathode and battery preparation compositions is also an important factor to consider when preparing these compositions as well as when preparing cathodes using these compositions. In particular, compatibility, and in particular the absence of solubility or low solubility, with the electrolyte in the battery is an essential property.

Easy, uniform application of cathode preparation compositions is desirable in order to obtain a uniform coat and to limit or avoid flaws on the surface of the electrode, resulting in a uniform and particularly effective conductive coat. Surface levelling, restructuring and flow behaviour of cathode preparation compositions must be well controlled.

Cathode preparation compositions must also be stable and homogenous during their preparation, storage or application. Settling, cluster or aggregate formation and ingredient separation must therefore be limited or avoided.

In general, improving the adhesion of the active elements should always be sought when preparing the cathode. The adhesion of the different coats of ingredients deposited on the metallic substrate must therefore be improved. In particular, when a primer coating comprising carbon is deposited on the metallic substrate, improving its adhesion is essential. Because they are in direct contact with the metallic cathode substrate and with the binding composition of the electroactive compound, the properties of primer coating compositions are particularly important.

Document CN 115881966 describes a conductive adhesive formulation consisting of 2 polymer compositions grafted using conductive monomers. Document US20170018770 describes the preparation of a cathode using a composition comprising electroactive LiNiMn particles. Document KR 1020190143256 describes the preparation of an anode using electroactive and binding compositions comprising silicon particles.

The commonly-used compositions for preparing cathode primer coatings in the prior art are not always satisfactory. There is thus a need for compositions for use when preparing cathode primer coatings that provide solutions to all or part of the problems of the compositions in the prior art.

The invention thus provides a method for preparing a cathode primer coating comprising:
applying:
   at least one binding agent Q comprising at least one water-soluble polymer P1, with a molecular mass Mw, measured by SEC, ranging from more than 100,000 g/mol to 1,000,000 g/mol, prepared by a polymerisation reaction, in the presence of at least one initiator compound, of at least one compound (a1) chosen among acrylic acid, methacrylic acid, an acrylic acid oligomer, a methacrylic acid oligomer, an acrylic acid salt, a methacrylic acid salt, an acrylic acid oligomer salt, a methacrylic acid oligomer salt and combinations thereof,
   at least one binding agent R comprising at least one water-soluble polymer P2, with a molecular mass Mw, measured by SEC, ranging from 2,000 g/mol to strictly less than 100,000 g/mol, prepared by a polymerisation reaction, in the presence of at least one initiator compound, of at least one compound (a2) chosen among acrylic acid, methacrylic acid, an acrylic acid oligomer, a methacrylic acid oligomer, an acrylic acid salt, a methacrylic acid salt, an acrylic acid oligomer salt, a methacrylic acid oligomer salt and combinations thereof and
   at least one material E comprising carbon particles;
drying the primer coating.

The invention thus provides a method for preparing a cathode primer coating. Preferably, the primer coating obtained according to the invention comprises no silicon or electroactive metallic compound.

Preferably for the method according to the invention, compound (a1) is chosen among acrylic acid, methacrylic acid, an acrylic acid salt, a methacrylic acid salt and combinations thereof, preferably compound (a1) is acrylic acid or methacrylic acid.

The polymer P1 used according to the invention is a water-soluble polymer. Preferably according to the invention, polymer P1 is water-soluble at a pH greater than 4.

Preferably according to the invention, polymer P1 can be a homopolymer of compound (a1). Also preferably according to the invention, polymer P1 can be a copolymer of compounds (a1) or a copolymer of at least one compound (a1) and of at least one other compound (b).

Preferably, compound (b) is chosen among:
a compound (b1) chosen among C₁-C₁₂ methacrylic acid esters, C₁-C₁₂ acrylic acid esters and combinations thereof, preferably C₁-C₈ methacrylic acid esters, C₁-C₈ acrylic acid esters and combinations thereof, preferably methyl methacrylate, ethyl methacrylate, propyl methacrylate, butyl methacrylate, methyl acrylate, ethyl acrylate, propyl acrylate, butyl acrylate, more preferentially, methyl acrylate, ethyl acrylate, butyl acrylate;
a compound (b2) chosen among acrylonitrile, acrylamide, N-methylolacrylamide, vinyl lactam, N-vinylpyrrolidone, ureido methacrylate and combinations thereof, preferably acrylonitrile;
a compound (b3) chosen among maleic acid, maleic anhydride, itaconic acid, crotonic acid and combinations thereof;
a compound (b4) chosen among hydroxyethyl acrylate, hydroxyethyl methacrylate, hydroxypropyl acrylate, hydroxypropyl methacrylate, hydroxybutyl methacrylate, caprolactone methacrylate, caprolactone acrylate, polycaprolactone methacrylate, polycaprolactone acrylate, lactam methacrylate, lactam acrylate, polycaprolactam methacrylate, polycaprolactam acrylate, styrene, more preferentially styrene;
a compound (b5) chosen among 2-acrylamido-2-methylpropane sulphonic acid, a 2-acrylamido-2-methylpropane sulphonic acid salt, ethoxy methacrylate sulphonic acid, sodium methallyl sulphonate, styrene sulphonate, hydroxyethyl acrylate phosphate, hydroxyethyl methacrylate phosphate, hydroxypropyl acrylate phosphate, hydroxypropyl methacrylate phosphate, hydroxybutyl methacrylate phosphate;
a cross-linking compound (b6).

According to the invention, polymer P1 can only be prepared by a polymerisation reaction of monomer (a1) and optionally of at least one compound (b) chosen among compounds (b1) to (b6). Preferably according to the invention, polymer P1 is not cross-linked, in particular using calcium acetate, calcium hydroxide, calcium bicarbonate or calcium oxalate. Also preferably, compound (b) is not acrylonitrile or acrylamide or it comprises no fluorine; polymer P1 is thus not a fluorinated polymer. Also preferably according to the invention, polymer P1 is a free polymer, it is not grafted, in particular it is not grafted to a fluorinated polymer or it is not grafted to a polyaniline, a polypyrrole, a polythiophene, a polyparaphenylene or to a polyphenylacetylene.

According to the invention, polymer P1 is not a conductive polymer.

The amounts of monomers present in polymer P1 can vary relatively widely. Preferably according to the invention, polymer P1 can be prepared by a polymerisation reaction of from 55% by weight to 100% by weight of compound (a1) and from 0% by weight to 45% by weight of compound (b).

Also preferably, polymer P1 can be prepared by a polymerisation reaction of from 55% by weight to 90% by weight of compound (a1) and from 10% by weight to 45% by weight of compound (b) or from 55% by weight to 80% by weight of compound (a1) and from 20% by weight to 45% by weight of compound (b).

According to the invention, polymer P1 can also be prepared by a polymerisation reaction of from 55% by weight to 70% by weight of compound (a1) and from 30% by weight to 45% by weight of compound (b).

Essentially according to the invention, polymer P1 has a molecular mass Mw, measured by SEC, greater than 100,000 g/mol. Preferably according to the invention, polymer P1 has a molecular mass Mw, measured by SEC, ranging from 120,000 g/mol to 800,000 g/mol or from 150,000 g/mol to 800,000 g/mol.

Also preferably according to the invention, polymer P1 has a molecular mass Mw, measured by SEC, ranging from 200,000 g/mol to 800,000 g/mol or from 250,000 g/mol to 800,000 g/mol.

More preferentially according to the invention, polymer P1 has a molecular mass Mw, measured by SEC, ranging from 120,000 g/mol to 500,000 g/mol or from 150,000 g/mol to 500,000 g/mol or from 200,000 g/mol to 500,000 g/mol or from 250,000 g/mol to 500,000 g/mol.

According to the invention, the molecular weight or mass of polymers P1 and P2 is determined by Size Exclusion Chromatography (SEC). A test portion of the polymer solution corresponding to 90 mg of dry solids content is placed into a 10 mL flask. Mobile phase is added, together with 0.04% of dimethylformamide (DMF), until a total mass of 10 g is reached. The composition of this mobile phase is as follows: NaHCO₃:0.05 mol/L, NaNO₃: 0.1 mol/L, triethanolamine: 0.02 mol/L, NaN₃ 0.03% by mass. The SEC chain is composed of a “Waters” 510 isocratic pump with a flow rate set to 0.8 mL/min, of a “Waters” 717+ sample changer, of an oven containing a “Waters Ultrahydrogel Column Guard” precolumn 6 cm long and 40 mm in inner diameter, followed by a “Waters Ultrahydrogel” linear column 30 cm long and 7.8 mm in inner diameter. Detection is provided by means of a “Waters” 410 RI differential refractometer. The oven is brought to a temperature of 60° C. and the refractometer is brought to a temperature of 45° C. The SEC instrument is calibrated with a series of polyacrylate sodium standards supplied by “Polymer Standards Service” with a molecular weight at the top of the peak comprised between 1,000 g/mol and 1.106 g/mol and a polymolecularity index comprised between 1.4 and 1.7. The calibration curve is straight-line and takes into account the correction obtained using the flow rate marker: dimethylformamide (DMF). Acquisition and processing of the chromatogram are performed using “PSS WinGPC Scientific” software v 4.02. The chromatogram obtained is incorporated into the area corresponding to molecular weights of more than 250 g/mol.

Also preferably according to the invention, polymer P1 has a glass transition temperature Tg, calculated using the Flory-Fox equation, ranging from −10° C. to 230° C. or from 20° C. to 230° C. More preferably according to the invention, polymer P1 is a homopolymer with a Tg greater than 0° C., preferably greater than 10° C.

Also more preferably according to the invention, polymer P1 is a copolymer with a Tg greater than 50° C., preferably greater than 100° C.

The Flory-Fox equation enables the glass transition temperature of a copolymer to be calculated using the parameters of the monomers used in its preparation.

The polymer P1 used according to the invention can be used in its acid form or in a form in which all or some of its carboxyl groups can be neutralised. Preferably according to the invention, polymer P1 is therefore completely or partially acidic or completely or partially non-neutralised. More preferentially, polymer P1 is partially neutralised. According to the invention, polymer P1 is preferentially neutralised using at least one compound chosen among LiOH, NaOH, KOH, Zn(OH)₂, Mg(OH)₂, Ca(OH)₂, ZnO, MgO, CaO, ammonium derivatives, ammoniac, ammonia, amino bases, for example triethanolamine, aminomethyl propanol or 2-amino-2-methyl propanol (AMP) and combinations thereof, more preferentially LiOH or Zn(OH)₂ or ZnO.

According to the invention, polymer P1 is prepared by a polymerisation reaction at a temperature greater than 50° C., preferably at a temperature ranging from 60° C. to 95° C. or ranging from 65° C. to 90° C., in particular at a temperature ranging from 70° C. to 85° C.

Preferably, the initiator compound, for the preparation of polymer P1 or of polymer P2, is independently chosen among peroxides, hydroperoxides, persulphates and combinations thereof. More preferably according to the invention, the initiator compound is chosen among hydrogen peroxide, tert-butyl hydroperoxide, benzoyl peroxide, acetyl peroxide, lauryl peroxide, tert-butyl hydroperoxide, cumene hydroperoxide, ammonium persulphate, an alkali metal persulphate (in particular sodium persulphate, potassium persulphate), an azo compound and combinations thereof or associations thereof with an ion chosen among Fe^{II}, Fe^{III}, Cu^{I}, Cu^{II} and combinations thereof. According to the invention, the initiator compound can also be an organic compound, preferably an organic initiator compound chosen among compounds with an azo group, preferably chosen among 4,4′-azobis(4-cyanovaleric) acid (CAS No. 2638-94-0), 2,2′-azobis(2-methylpropionamidine) dihydrochloride (CAS No. 2997-92-4), azo-bis-isobutyronitrile (AZDN or AIBN) and combinations thereof.

Essentially, the method for preparing a cathode primer coating according to the invention comprises applying binders Q and R and material E and drying the primer coating. Preferably for the method according to the invention, binding agent Q comprises at least one polymer P1 and at least one liquid substrate, preferably water, alone or combined with at least one polar solvent, for example a solvent chosen among ethanol, isopropanol and combinations thereof.

Also preferentially according to the invention, binding agent Q comprises:
from 5% by weight to 60% by weight of polymer P1 and from 40% by weight to 95% by weight of liquid substrate, more preferentially:
from 10% by weight to 40% by weight of polymer P1 and from 60% by weight to 90% by weight of liquid substrate.

Preferably for the method according to the invention, compound (a2) is chosen among acrylic acid, methacrylic acid, an acrylic acid salt, a methacrylic acid salt and combinations thereof, preferably compound (a2) is acrylic acid or methacrylic acid.

The polymer P2 used according to the invention is a water-soluble polymer. Preferably according to the invention, polymer P2 is water-soluble at a pH greater than 4.

Polymer P2 can be a homopolymer of compound (a2). Preferably according to the invention, polymer P2 can be a copolymer of compounds (a2) or a copolymer of at least one compound (a2) and at of least one other compound (c). More preferably according to the invention, polymer P2 is a copolymer of at least one compound (a2) and of at least one other compound (c).

Preferably, compound (c) is chosen among:
a compound (c1) chosen among C₁-C₁₂ methacrylic acid esters, C₁-C₁₂ acrylic acid esters and combinations thereof, preferably C₁-C₈ methacrylic acid esters, C₁-C₈ acrylic acid esters and combinations thereof, preferably methyl methacrylate, ethyl methacrylate, propyl methacrylate, butyl methacrylate, methyl acrylate, ethyl acrylate, propyl acrylate, butyl acrylate, more preferentially, methyl acrylate, ethyl acrylate, butyl acrylate;
a compound (c2) chosen among acrylonitrile, acrylamide, N-methylolacrylamide, vinyl lactam, N-vinylpyrrolidone, ureido methacrylate and combinations thereof, preferably acrylonitrile;
a compound (c3) chosen among maleic acid, maleic anhydride, itaconic acid, crotonic acid and combinations thereof;
a compound (c4) chosen among hydroxyethyl acrylate, hydroxyethyl methacrylate, hydroxypropyl acrylate, hydroxypropyl methacrylate, hydroxybutyl methacrylate, caprolactone methacrylate, caprolactone acrylate, polycaprolactone methacrylate, polycaprolactone acrylate, lactam methacrylate, lactam acrylate, polycaprolactam methacrylate, polycaprolactam acrylate, styrene, more preferentially styrene;
a compound (c5) chosen among 2-acrylamido-2-methylpropane sulphonic acid, a 2-acrylamido-2-methylpropane sulphonic acid salt, ethoxy methacrylate sulphonic acid, sodium methallyl sulphonate, styrene sulphonate, hydroxyethyl acrylate phosphate, hydroxyethyl methacrylate phosphate, hydroxypropyl acrylate phosphate, hydroxypropyl methacrylate phosphate, hydroxybutyl methacrylate phosphate;
a cross-linking compound (c6).

According to the invention, polymer P2 can only be prepared by a polymerisation reaction of monomer (a2) and optionally of at least one compound (c) chosen among compounds (c1) to (c6).

Preferably according to the invention, polymer P2 is a free polymer, it is not grafted, in particular it is not grafted to a fluorinated polymer or it is not grafted to a polyaniline, a polypyrrole, a polythiophene, a polyparaphenylene or to a polyphenylacetylene. Also preferably according to the invention, polymer P2 comprises no urethane group.

According to the invention, polymer P2 is not a conductive polymer.

The amounts of monomers present in polymer P2 can vary relatively widely. Preferably according to the invention, polymer P2 can be prepared by a polymerisation reaction of from 55% by weight to 100% by weight of compound (a2) and from 0% by weight to 45% by weight of compound (c).

Also preferably, polymer P2 can be prepared by a polymerisation reaction of from 55% by weight to 90% by weight of compound (a2) and from 10% by weight to 45% by weight of compound (c) or from 55% by weight to 80% by weight of compound (a2) and from 20% by weight to 45% by weight of compound (c).

According to the invention, polymer P2 can also be prepared by a polymerisation reaction of from 55% by weight to 70% by weight of compound (a2) and from 30% by weight to 45% by weight of compound (c).

Essentially according to the invention, polymer P2 has a molecular weight Mw, measured by SEC, of strictly less than 100,000 g/mol. Preferably according to the invention, polymer P2 has a molecular mass Mw, measured by SEC, ranging from 2,000 g/mol to 80,000 g/mol or from 2,000 g/mol to 50,000 g/mol.

Also preferably according to the invention, polymer P2 has a molecular mass Mw, measured by SEC, ranging from 2,000 g/mol to 40,000 g/mol or from 2,000 g/mol to 30,000 g/mol. More preferentially according to the invention, polymer P2 has a molecular mass Mw, measured by SEC, ranging from 2,000 g/mol to 25,000 g/mol or from 2,000 g/mol to 20,000 g/mol or from 5,000 g/mol to 25,000 g/mol or from 5,000 g/mol to 20,000 g/mol.

Also preferably according to the invention, polymer P2 has a glass transition temperature Tg, calculated using the Flory-Fox equation, ranging from −10° C. to 230° C. or from 20° C. to 230° C. More preferably according to the invention, polymer P2 is a homopolymer with a Tg greater than 0° C., preferably greater than 10° C.

Also more preferably according to the invention, polymer P2 is a copolymer with a Tg greater than 50° C., preferably greater than 100° C.

The polymer P2 used according to the invention can be used in its acid form or in a form in which all or some of its carboxyl groups can be neutralised. Preferably according to the invention, polymer P2 is therefore completely or partially acidic or completely or partially non-neutralised. More preferentially, polymer P2 is partially neutralised. According to the invention, polymer P2 is preferentially neutralised using at least one compound chosen among LiOH, NaOH, KOH, Zn(OH)₂, Mg(OH)₂, Ca(OH)₂, ZnO, MgO, CaO, ammonium derivatives, ammoniac, ammonia, amino bases, for example triethanolamine, aminomethyl propanol or 2-amino-2-methyl propanol (AMP) and combinations thereof, more preferentially LiOH or Zn(OH)₂ or ZnO.

According to the invention, polymer P2 is prepared by a polymerisation reaction at a temperature greater than 50° C., preferably at a temperature ranging from 60° C. to 95° C. or ranging from 65° C. to 90° C., in particular at a temperature ranging from 70° C. to 85° C.

Preferably for the method according to the invention, binding agent R comprises at least one polymer P2 and at least one liquid substrate, preferably water, alone or combined with at least one polar solvent, for example a solvent chosen among ethanol, isopropanol and combinations thereof.

Also preferentially according to the invention, binding agent R comprises:
from 5% by weight to 60% by weight of polymer P2 and from 40% by weight to 95% by weight of liquid substrate, more preferentially:
from 10% by weight to 40% by weight of polymer P2 and from 60% by weight to 90% by weight of liquid substrate.

Essentially according to the invention, material E comprises carbon particles. Preferably according to the invention, material E is chosen among carbon black, acetylene black, Ketjen black, carbon fibres, carbon nanotubes, carbon nanofibres, hard carbon and combinations thereof.

The method according to the invention makes it possible to prepare a cathode primer coating. It comprises applying binding agents Q and R and material E and drying the primer coating. Preferably for the method according to the invention, binding agents Q and R and material E are applied to a metallic substrate comprising at least one metal chosen among aluminium, nickel and combinations thereof. Aluminium is particularly preferred.

According to the invention, the preparation method can comprise calendering the metallic substrate carrying the primer coating.

Preferably for the method according to the invention, binding agent Q and material E are applied simultaneously and agent R is applied separately. Also preferably, binding agent Q and material E are applied simultaneously then agent R is subsequently applied separately. More preferentially according to the invention, binding agent Q, agent R and material E are applied simultaneously.

More preferably, the method according to the invention comprises applying a composition QE comprising binding agent Q and material E and a composition RE comprising binding agent R and material E. More preferably, it comprises applying a composition QE comprising binding agent Q and material E then a composition RE comprising binding agent R and material E.

Also more preferably, the method according to the invention comprises applying a composition QE comprising binding agent Q and material E and binding agent R. More preferably, it comprises applying a composition QE comprising binding agent Q and material E then binding agent R.

Also more preferably, the method according to the invention comprises applying a composition QRE comprising binding agent Q, binding agent R and material E.

The method for preparing a cathode primer coating according to the invention comprises applying binding agents Q and R and material E. The application can be used by means of a particular composition. Thus, the invention also provides a composition QRE, preferably an aqueous composition QRE, for preparing a cathode primer coating, comprising:
at least one binding agent Q comprising at least one water-soluble polymer P1, with a molecular mass Mw, measured by SEC, ranging from more than 100,000 g/mol to 1,000,000 g/mol, prepared by a polymerisation reaction, in the presence of at least one initiator compound, of at least one compound (a1) chosen among acrylic acid, methacrylic acid, an acrylic acid oligomer, a methacrylic acid oligomer, an acrylic acid salt, a methacrylic acid salt, an acrylic acid oligomer salt, a methacrylic acid oligomer salt and combinations thereof,
at least one binding agent R comprising at least one water-soluble polymer P2, with a molecular mass Mw, measured by SEC, ranging from 2,000 g/mol to strictly less than 100,000 g/mol, prepared by a polymerisation reaction, in the presence of at least one initiator compound, of at least one compound (a2) chosen among acrylic acid, methacrylic acid, an acrylic acid oligomer, a methacrylic acid oligomer, an acrylic acid salt, a methacrylic acid salt, an acrylic acid oligomer salt, a methacrylic acid oligomer salt and combinations thereof, and
at least one material E comprising carbon particles.

Preferably according to the invention, composition QRE comprises, by dry weight:
from 0.5% to 40% of binding agent Q,
from 0.5% to 30% of binding agent R,
from 30% to 99% of material E,
relative to the total amount by dry weight of binding agents Q and R and of material E.

Preferably according to the invention, it comprises, by dry weight:
from 0.5% to 50% of binding agent Q,
from 0.5% to 20% of binding agent R,
from 30% to 99% of material E,
relative to the total amount by dry weight of binding agents Q and R and of material E.

Preferably according to the invention, composition QRE comprises water, alone or combined with at least one polar solvent, for example a solvent chosen among ethanol, isopropanol and combinations thereof. More preferably according to the invention, composition QRE comprises no polar solvent or comprises no solvent chosen among ethanol, isopropanol and combinations thereof, in particular no isopropanol.

Very advantageously, the method for preparing a cathode primer coating can be used when preparing a cathode. The invention thus also provides a method for preparing a cathode comprising:
applying, to a metallic substrate comprising at least one metal chosen among aluminium, nickel and combinations thereof, a primer coating obtained by applying:
   at least one binding agent Q comprising at least one water-soluble polymer P1, with a molecular mass Mw, measured by SEC, ranging from more than 100,000 g/mol to 1,000,000 g/mol, prepared by a polymerisation reaction, in the presence of at least one initiator compound, of at least one compound (a1) chosen among acrylic acid, methacrylic acid, an acrylic acid oligomer, a methacrylic acid oligomer, an acrylic acid salt, a methacrylic acid salt, an acrylic acid oligomer salt, a methacrylic acid oligomer salt and combinations thereof,
   at least one binding agent R comprising at least one water-soluble polymer P2, with a molecular mass Mw, measured by SEC, ranging from 2,000 g/mol to strictly less than 100,000 g/mol, prepared by a polymerisation reaction, in the presence of at least one initiator compound, of at least one compound (a2) chosen among acrylic acid, methacrylic acid, an acrylic acid oligomer, a methacrylic acid oligomer, an acrylic acid salt, a methacrylic acid salt, an acrylic acid oligomer salt, a methacrylic acid oligomer salt and combinations thereof, and
   at least one material E comprising carbon particles;
drying the primer coating, then optionally calendering the metallic substrate carrying the primer coating, then
applying, to the primer coating, an electroactive composition comprising at least one electroactive compound, at least one binding compound of the electroactive compound and at least one organic solvent,
drying then calendering the metallic substrate carrying the primer coating and the electroactive coating.

The method for preparing a cathode according to the invention therefore comprises preparing a cathode primer coating defined according to the invention.

Preferably according to the invention, the metallic substrate is a purely metallic substrate or a composite substrate comprising at least one metal and at least one insulating substrate. Also preferably according to the invention, the electroactive compound comprises at least one metal chosen among lithium, iron, nickel, manganese, cobalt and combinations thereof. Also preferably according to the invention, the electroactive compound is in the form of a metal salt, preferably a polymetallic salt, more preferably the electroactive compound is chosen among LiFePO₄ (LFP), Li(Ni,Mn,Co) O₂ (NMC) and combinations thereof.

Preferably according to the invention, the binding compound of the electroactive compound is chosen among polyvinylidene fluoride (PVDF). Preferentially according to the invention, the binding compound of the electroactive compound is not a (meth)acrylic polymer.

Preferably according to the invention, the organic solvent is an aprotic polar solvent, preferably chosen among pyrrolidone, N-methyl-pyrrolidone (NMP), alkyl carbonates and combinations thereof.

Also preferably according to the invention, the electroactive composition comprises carbon, preferably chosen among carbon black, acetylene black, Ketjen black, carbon fibres, carbon nanotubes, carbon nanofibres, hard carbon and combinations thereof.

This preparation method according to the invention makes it possible to obtain a cathode with particularly advantageous properties. The invention thus also provides a cathode comprising at least one metallic substrate coated with at least one primer coating comprising a binding agent Q, a binding agent R and at least one material E according to the invention. Preferably, the cathode according to the invention is obtained using the method for preparing a primer coating according to the invention or a method for preparing a cathode according to the invention. Also preferably, the cathode according to the invention is prepared using a composition QRE according to the invention. Particularly preferably according to the invention, the composition QRE according to the invention comprises a greater amount of polymer P1 by mass than the amount of polymer P2 by mass.

The combination of polymers P1 and P2 in the binding agents Q and R used according to the invention has particularly advantageous properties for the preparation of a cathode primer coating and therefore for obtaining a cathode. This combination of polymers used according to the invention improves adhesion to the metallic substrate of the cathode. In particular, it improves adhesion on the metallic substrate when used in combination with the binding compound of the electroactive compound. The compatibility of polymers P1 and P2, in particular the compatibility of polymer P2, and of the binding compound of the electroactive compound is particularly advantageous when preparing a cathode.

Thus, the invention also provides a method for improving the adhesion to a metallic cathode substrate comprising at least one metal chosen among aluminium, nickel and combinations thereof, of an electroactive composition comprising at least one electroactive compound, at least one binding compound of the electroactive compound and at least one organic solvent, comprising:
pre-applying directly on the metallic substrate, then optionally drying and optionally calendering, at least one aqueous primer coating preparation composition comprising:
   at least one binding agent Q comprising at least one water-soluble polymer P1, with a molecular mass Mw, measured by SEC, ranging from more than 100,000 g/mol to 1,000,000 g/mol, prepared by a polymerisation reaction, in the presence of at least one initiator compound, of at least one compound (a1) chosen among acrylic acid, methacrylic acid, an acrylic acid oligomer, a methacrylic acid oligomer, an acrylic acid salt, a methacrylic acid salt, an acrylic acid oligomer salt, a methacrylic acid oligomer salt and combinations thereof,
   at least one binding agent R comprising at least one water-soluble polymer P2, with a molecular mass Mw, measured by SEC, ranging from 2,000 g/mol to strictly less than 100,000 g/mol, prepared by a polymerisation reaction, in the presence of at least one initiator compound, of at least one compound (a2) chosen among acrylic acid, methacrylic acid, an acrylic acid oligomer, a methacrylic acid oligomer, an acrylic acid salt, a methacrylic acid salt, an acrylic acid oligomer salt, a methacrylic acid oligomer salt and combinations thereof, and
   at least one material E comprising carbon particles, then
applying the electroactive composition,
drying then calendering the metallic substrate carrying the primer coating and the electroactive coating.

The combination of polymers P1 and P2, and in particular polymer P2, used according to the invention make it possible to improve subsequent adhesion with the binding compound of the electroactive compound. This combination, and in particular polymer P2, acts as an adhesion promoter between the metallic substrate and this binding compound of the electroactive compound. They also contribute to the adhesion of the carbon particles of material E to the metallic substrate.

The advantageous, particular or preferred characteristics of the method for preparing a cathode primer coating according to the invention define methods for preparing a cathode according to the invention, primer coating preparation compositions, methods for improving adhesion to a metallic cathode substrate, and cathodes, that are also advantageous, particular or preferred.

The various aspects of the invention can be illustrated by examples.

### EXAMPLES

### Preparation and Characterisation of Polymers P1 and P2 and Agents Q and R According to the Invention

Polymer P1.1 and agent Q1:

498 g of deionised water are introduced into a 1 L glass reactor with mechanical stirring and oil bath heating. The mixture is then heated to around 95° C. and the following are added in 120 minutes using peristaltic pumps:
in a first test sample, 270 g of acrylic acid,
in a second test sample, 2.55 g of ammonium persulphate dissolved in 50 g of deionised water.

Heating is then continued for 60 minutes. The mixture is then cooled, then diluted to obtain agent Q1 according to the invention, which has a dry solids content of 25% by weight, a pH of 2.3 and which comprises polymer P1.1 with a molecular mass Mw, measured by SEC, of 220,000 g/mol.

### Polymer P1.2 and Agent Q2:

498 g of deionised water are introduced into a 1 L glass reactor with mechanical stirring and oil bath heating. The mixture is then heated to around 95° C. and the following are added in 120 minutes using peristaltic pumps:
in a first test sample, 270 g of acrylic acid,
in a second test sample, 1.8 g of ammonium persulphate dissolved in 50 g of deionised water.

Heating is then continued for 60 minutes. The mixture is then cooled, then diluted to obtain agent Q2 according to the invention, which has a dry solids content of 25% by weight, a pH of 2.3 and which comprises polymer P1.2 with a molecular mass Mw, measured by SEC, of 125,000 g/mol.

### Polymer P1.3 and Agent Q3:

498 g of deionised water are introduced into a 1 L glass reactor with mechanical stirring and oil bath heating. The mixture is then heated to around 95° C. and the following are added in 120 minutes using peristaltic pumps:
in a first test sample, 270 g of acrylic acid,
in a second test sample, 5.2 g of ammonium persulphate dissolved in 50 g of deionised water.

Heating is then continued for 60 minutes. The mixture is then cooled, then diluted to obtain agent Q3 according to the invention, which has a dry solids content of 25% by weight, a pH of 2.3 and which comprises polymer P1.3 with a molecular mass Mw, measured by SEC, of 305,000 g/mol.

### Polymer P1.4 and Agent Q4:

90 g of acrylic acid (monomer a), 10 g of ethyl acrylate (monomer b) and 875 g of deionised water are introduced into a 1 L glass reactor with mechanical stirring and oil bath heating. This is heated to 70° C. A solution comprising 0.35 g of ammonium persulphate in 10 g of deionised water is then poured in all at once.

Heating is then continued for 60 minutes to 85° C. A solution comprising 0.35 g of ammonium persulphate in 20 g of deionised water is again poured in all at once.

Heating is then continued for 60 minutes. The mixture is then cooled, then diluted to obtain agent Q4 according to the invention, which has a dry solids content of 10.4% by weight, a pH of 2.5 and which comprises polymer P1.4 with a molecular mass Mw, measured by SEC, of 256,000 g/mol.

### Polymer P1.5 and Agent Q5:

100 g of acrylic acid (monomer a) and 875 g of deionised water are introduced into a 1 L glass reactor with mechanical stirring and oil bath heating.

This is heated to 70° C. A solution comprising 0.45 g of ammonium persulphate in 10 g of deionised water is then poured in all at once.

Heating is then continued for 60 minutes to 85° C. The mixture is then cooled, then diluted to obtain agent Q5 according to the invention, which has a dry solids content of 10.4% by weight, a pH of 2.5 and which comprises polymer P1.5 with a molecular mass Mw, measured by SEC, of 370,000 g/mol.

### Polymer P2.1 and Agent R1:

200 g of isopropanol and 1.7 g of AZDN are weighed into a 1 L reactor equipped with mechanical stirring, oil bath heating and peristaltic pumps. The mixture is then heated under reflux to around 80° C. and 200 g of acrylic acid and 81 g of butyl acrylate are added in 120 minutes using the peristaltic pumps. Then, the reflux heating is continued for 60 minutes.

The isopropanol is then distilled and it is gradually replaced with water during distillation. The mixture is then cooled, then diluted to obtain agent R1 according to the invention, which has a dry solids content of 40% by weight, a pH of 2.3 and which comprises polymer P2.1 with a molecular mass Mw, measured by SEC, of 9,000 g/mol.

### Polymer P2.2 and Agent R2:

200 g of isopropanol and 1.7 g of AZDN are weighed into a 1 L reactor equipped with mechanical stirring, oil bath heating and peristaltic pumps. The mixture is then heated under reflux to around 80° C. and 200 g of acrylic acid and 80 g of ethyl acrylate are added in 120 minutes using the peristaltic pumps. Then, the reflux heating is continued for 60 minutes. The isopropanol is then distilled and it is gradually replaced with water during distillation.

The mixture is then cooled, then diluted to obtain agent R2 according to the invention, which has a dry solids content of 40% by weight, a pH of 2.2 and which comprises polymer P2.2 with a molecular mass Mw, measured by SEC, of 9,500 g/mol.

### Polymer P2.3 and Agent R3:

200 g of isopropanol and 1.9 g of AZDN are weighed into a 1 L reactor equipped with mechanical stirring, oil bath heating and peristaltic pumps. The mixture is then heated under reflux to around 80° C. and 200 g of acrylic acid and 83 g of methyl methacrylate are added in 120 minutes using the peristaltic pumps. Then, the reflux heating is continued for 60 minutes. The isopropanol is then distilled and it is gradually replaced with water during distillation.

The mixture is then cooled, then diluted to obtain agent R3 according to the invention, which has a dry solids content of 40% by weight, a pH of 2.5 and which comprises polymer P2.3 with a molecular mass Mw, measured by SEC, of 8,000 g/mol.

### Polymer P2.4 and Agent R4:

209.7 g of water, 0.08 g of iron sulphate heptahydrate and 0.011 g of copper sulphate pentahydrate are weighed into a 1 L reactor equipped with mechanical stirring, oil bath heating and peristaltic pumps. The mixture is then heated to 95° C. and 302.5 g of acrylic acid and 13 g of water, 25.6 g of sodium hypophosphite monohydrate dissolved in 29 g of water, and 20.46 g of 130V hydrogen peroxide diluted with 25 g of water are added in 120 minutes using the peristaltic pumps. Heating is then continued for 60 minutes.

The mixture is then cooled, then diluted to obtain agent R4 according to the invention, which has a dry solids content of 40% by weight, a pH of 2.1 and which comprises polymer P2.4 with a molecular mass Mw, measured by SEC, of 4,400 g/mol.

### Polymer P2.5 and Agent R5:

121 g of water, 121 g of isopropanol, 0.06 g of iron sulphate heptahydrate and 11 g of hydrazine hydrate at 35% concentration in water are weighed into a 1 L reactor equipped with mechanical stirring, oil bath heating and peristaltic pumps. The mixture is then heated under reflux to around 81° C. and the following are added in 120 minutes using the peristaltic pumps:
in a first test sample, 174 g of acrylic acid, 35 g of methyl methacrylate, 110 g of ethylene glycol phosphate and 80 g of water,
in a second test sample, 20 g of 130V hydrogen peroxide and 100 g of water.

After the additions have been completed, heating is continued under reflux for 60 minutes at 80° C., then the isopropanol is distilled with the addition of water during distillation. The mixture is then cooled, then diluted to obtain agent R5 according to the invention, which has a dry solids content of 40% by weight, a pH of 2.0 and which comprises polymer P2.5 with a molecular mass Mw, measured by SEC, of 15,000 g/mol.

### Polymer P2.6 and Agent R6:

200 g of isopropanol and 2 g of AZDN are weighed into a 1 L reactor equipped with mechanical stirring, oil bath heating and peristaltic pumps. The mixture is then heated under reflux to around 80° C. and 200 g of acrylic acid and 80 g of a caprolactone acrylate marketed by the “Arkema” Group under reference SR 495B are added in 120 minutes using the peristaltic pumps. Then, the reflux heating is continued for 60 minutes. The isopropanol is then distilled and it is gradually replaced with water during distillation. The mixture is then cooled, then diluted to obtain agent R6 according to the invention, which has a dry solids content of 40% by weight, a pH of 2.3 and which comprises polymer P2.6 with a molecular mass Mw, measured by SEC, of 7,500 g/mol.

### Preparation of Aqueous Compositions ORE for Preparing a Cathode Primer Coating According to the Invention

150 g of deionised water are weighed with 28 g of agent Q1 and 7.5 g of agent R1 according to the invention, then mixed under stirring using a dispersing instrument (VMI) fitted with a toothed blade 6.5 cm in diameter. Then 10 g of carbon black (“Imerys” C-Nergy Super C65) are added while continuing to stir for 1.25 hours at 1,500 rpm to obtain a composition which is checked for homogeneity and absence of aggregates using a North gauge. The composition QRE1 is obtained using agents Q1 and R1.

Similarly, cathode primer coating compositions QRE2 to QRE14 are prepared using agents Q1 to Q5 and R1 to R6 in the respective amounts of dry solids content of polymers P1 and P2 and a total amount of 10 g of dry solids content of polymers P1 and P2 present in agents Q and R and described in Table 1.

### Preparation and Characterisation of Cathodes According to the Invention

On an aluminium sheet degreased with acetone, 12 μm of cathode primer coating preparation composition QRE1 according to the invention is applied using a coater equipped with a threaded rod (RK Control Coater), at an application speed of 10 mm/s. It is then dried in an oven at 150° C. for 5 minutes. The primer coating obtained using composition QRE1 applied then dried has a mass, measured using a precision balance, of 0.2 mg for an aluminium disc 12 mm in diameter and 10 μm+/−1 μm thick.

Similarly, cathode primer coatings are prepared using compositions QRE2 to QRE14.

Adhesion to the aluminium cathode substrate of the primer coating obtained using compositions QRE1 to QRE14 according to the invention is assessed using a peel test. A standardised adhesive tape (“Intertape” 51596 CIC8091013) is manually applied to the cathode primer coating. The adhesive tape is then peeled off and the adhesion of the primer coating to the aluminium is visually assessed.

The compatibility of the primer coating prepared according to the invention with a secondary coat of binding agent is assessed for a polyvinylidene fluoride binding agent (“Arkema” “Kynar HSV900” PVDF) applied in an N-methylpyrrolidone (NMP) solvent medium.

A coat of PVDF binding agent is applied to a cathode primer coating obtained according to the method described above using a 5% concentration solution of PVDF in NMP, then applied as a 9 μm coat and dried in an oven at 150° C. for 5 minutes.

A standardised adhesive tape (‘Intertape’ 51596 CIC8091013) is manually applied to the cathode secondary coat. Then the adhesive tape is peeled off and the adhesion is visually assessed.

The results obtained for the adhesion of the primer coating and its compatibility with the PVDF secondary coat are shown in Table 1 according to the following scale:
1: aluminium sheet visible over most of the surface of the adhesive tape,
2: aluminium sheet visible over part of the surface of the adhesive tape,
3: aluminium sheet not visible on the surface of the adhesive tape,
4: primer coating largely intact,
5: primer coating fully intact.

Assessments 1 and 2 are unacceptable for use of the cathode in a secondary battery. Assessments 3 to 5 are acceptable for use of the cathode in a secondary battery. The results are shown in Table 1.

TABLE 1

| Composition | Mass content | Mass content | | Compat- |
|---|---|---|---|---|
| QRE | of P1 in Q | of P2 in R | Adhesion | ibility |
| 1 | P1-1 70% | P2-1 30% | 4 | 5 |
| 2 | P1-1 80% | P2-2 20% | 5 | 5 |
| 3 | P1-1 90% | P2-3 10% | 5 | 4 |
| 4 | P1-2 70% | P2-4 30% | 4 | 4 |
| 5 | P1-2 80% | P2-1 20% | 4 | 5 |
| 6 | P1-2 90% | P2-4 10% | 5 | 4 |
| 7 | P1-3 80% | P2-5 20% | 5 | 5 |
| 8 | P1-3 80% | P2-6 20% | 4 | 5 |
| 9 | P1-3 70% | P2-5 30% | 5 | 5 |
| 10 | P1-3 70% | P2-1 30% | 4 | 5 |
| 11 | P1-4 70% | P2-3 30% | 4 | 5 |
| 12 | P1-4 80% | P2-2 20% | 4 | 5 |
| 13 | P1-5 80% | P2-2 20% | 5 | 5 |
| 14 | P1-5 75% | P2-5 25% | 5 | 5 |

Binding agents Q and R comprising the polymers according to the invention make it possible to produce good quality adhesion primer coatings that hold the conductive carbon on the surface of the aluminium sheet very well. They also act as binding agents compatible with the PVDF secondary binding agent that is the polymeric constituent of the LFP coat, making it possible to increase the adhesion of the LFP coat to the cathode primer coating.

1. A method for preparing a cathode primer coating, the method comprising:
applying to a surface components comprising
a binding agent Q comprising a water-soluble polymer P1, with a molecular mass Mw, measured by SEC, in a range of from more than 100,000 to 1,000,000 g/mol, comprising, in polymerized form, compound (a1) comprising acrylic acid, methacrylic acid, an acrylic acid oligomer, a methacrylic acid oligomer, an acrylic acid salt, a methacrylic acid salt, an acrylic acid oligomer salt, and/or a methacrylic acid oligomer salt, the polymerization of the water-soluble polymer P1 comprising an initiator,
a binding agent R comprising a water-soluble polymer P2, with a molecular mass Mw, measured by SEC, in a range of from 2,000 to less than 100,000 g/mol, comprising, in polymerized form, a compound (a2) comprising acrylic acid, methacrylic acid, an acrylic acid oligomer, a methacrylic acid oligomer, an acrylic acid salt, a methacrylic acid salt, an acrylic acid oligomer salt, and/or a methacrylic acid oligomer, the polymerization of the water-soluble polymer P1 comprising an initiator, and
a material E comprising carbon particles,
to obtain a primer coating; and
drying the primer coating.

2. The method of claim 1, wherein
the compound (a1) comprises acrylic acid,
methacrylic acid, an acrylic acid salt, and/or a methacrylic acid salt and combinations thereof, or
the water-soluble polymer P1 is water-soluble at a pH greater than 4, or
the water-soluble polymer P1 is a homopolymer of compound (a1).

3. The method of claim 1, wherein
the water-soluble polymer P1 is prepared by a polymerization reaction
the compound (a1) in a range of from 55 to 100 wt. % and the compound (b) of from 0 to 45 wt. %, or
wherein the water-soluble polymer P1 has a molecular mass Mw, measured by SEC, in a range of from 120,000 to 800,000 g/mol, or
wherein the water-soluble polymer P1 has a glass transition temperature Tg, calculated using the Flory-Fox equation, in a range of from −10° C. to 230° C., or
wherein the water-soluble polymer P1 is at least partially neutralized.

4. The method of claim 1, wherein
the binding agent Q comprises the polymer P1 and a liquid substrate.

5. The method of claim 1, wherein the compound (a2) comprises the acrylic acid, methacrylic acid, acrylic acid salt, and/or methacrylic acid salt, or
wherein the water-soluble polymer P2 is water-soluble at a pH greater than 4, or
wherein the water-soluble polymer P2 is a homopolymer of the compound (a2); or
wherein the water-soluble polymer P2 is a copolymer of compounds (a2).

6. The method of claim 1, wherein the water-soluble polymer P2 is prepared by
polymerizing the compound (a2) in a range of from 55 to 100 wt. % and the compound (c) in a range of from 0 to 45 wt. %, or
wherein the water-soluble P2 has a molecular mass Mw, measured by SEC, in a range of from 2,000 to 80,000 g/mol, or
wherein the water-soluble P2 has a glass transition temperature Tg, calculated using the Flory-Fox equation, in a range of from −10° C. to 230° C., or
wherein the water-soluble P2 is at least partially neutralized.

7. The method of claim 1, wherein the binding agent R comprises the water-soluble polymer P2 and a liquid substrate,
wherein the binding agent R comprises:
the water-soluble polymer P2 in a range of from 5 to 60 wt. % and the liquid substrate in a range of from 40 to 95 wt. %.

8. The method of claim 1, wherein material E comprises carbon black, acetylene black, Ketjen black, carbon fibers, carbon nanotubes, carbon nanofibers, and/or hard carbon.

9. The method of claim 1, wherein
wherein the binding agents Q and R and material E are applied to a metallic substrate comprising aluminum and/or nickel.

10. A composition QRE, comprising:
a binding agent Q comprising a water-soluble polymer P1, with a molecular mass Mw, measured by SEC, in a range of from more than 100,000 to 1,000,000 g/mol, comprising, in polymerized form, compound (a1) comprising acrylic acid, methacrylic acid, an acrylic acid oligomer, a methacrylic acid oligomer, an acrylic acid salt, a methacrylic acid salt, an acrylic acid oligomer salt, and/or a methacrylic acid oligomer salt, the polymerization of the water-soluble polymer P1 comprising an initiator;
a binding agent R comprising a water-soluble polymer P2, with a molecular mass Mw, measured by SEC, in a range of from 2,000 to less than 100,000 g/mol, comprising, in polymerized form, compound (a2) acrylic acid, methacrylic acid, an acrylic acid oligomer, a methacrylic acid oligomer, an acrylic acid salt, a methacrylic acid salt, an acrylic acid oligomer salt, and/or a methacrylic acid oligomer salt, the polymerization of the water-soluble polymer P2 comprising an initiator; and
a material E comprising carbon particles.

11. The composition QRE of claim 10 comprising, by dry weight:
the binding agent Q, in a range of from 0.5 to 40%;
the binding agent R, in a range of from 0.5 to 30%; and
the material E, in a range of from 30 to 99%,
relative to a total amount by dry weight of the binding agents Q and R and the material E.

12. A method for preparing a cathode, the method comprising:
applying, to a metallic substrate comprising aluminum and/or nickel, a primer coating comprising:
a binding agent Q comprising a water-soluble polymer P1, with a molecular mass Mw, measured by SEC, in a range of from more than 100,000 to 1,000,000 g/mol, comprising, in polymerized form, compound (a1) comprising acrylic acid, methacrylic acid, an acrylic acid oligomer, a methacrylic acid oligomer, an acrylic acid salt, a methacrylic acid salt, an acrylic acid oligomer salt, and/or a methacrylic acid oligomer salt, the polymerization of the water-soluble polymer P1 comprising an initiator;
a binding agent R comprising a water-soluble polymer P2, with a molecular mass Mw, measured by SEC, in a range of from 2,000 to less than 100,000 g/mol, comprising, in polymerized form, compound (a2) acrylic acid, methacrylic acid, an acrylic acid oligomer, a methacrylic acid oligomer, an acrylic acid salt, a methacrylic acid salt, an acrylic acid oligomer salt, and/or a methacrylic acid oligomer salt, the polymerization of the water-soluble polymer P2 comprising an initiator; and
a material E comprising carbon particles;
drying the primer coating, then optionally calendering the metallic substrate carrying the primer coating; then
applying, to the primer coating, an electroactive composition comprising an electroactive compound, a binding compound of the electroactive compound, and an organic solvent,
drying then calendering the metallic substrate carrying the primer coating and the electroactive coating.

13. The method for preparing a cathode primer coating, the method comprising:
carrying out the method of claim 1,
wherein the surface is on a metallic substrate.

14. The method of claim 13, wherein the metallic
substrate is a purely metallic substrate or a composite substrate comprising a metal and an insulating substrate, or
wherein the electroactive compound comprises lithium, iron, nickel, manganese, and/or cobalt, or
wherein the electroactive compound is a metal salt, or
wherein the binding compound of the electroactive compound comprises polyvinylidene fluoride, or
wherein the organic solvent is an aprotic polar solvent, or
wherein the electroactive composition comprises carbon.

15. A cathode, comprising:
a metallic substrate comprising a primer coating comprising a binding agent Q, a binding agent R, and a material E.

16. A method for improving adhesion to a metallic cathode substrate of an electroactive composition, the method comprising:
pre-applying directly on the metallic substrate, then optionally drying and optionally calendering, at least one aqueous primer coating preparation composition comprising:
a binding agent Q comprising a water-soluble polymer P1, with a molecular mass Mw, measured by SEC, in a range of from more than 100,000 to 1,000,000 g/mol, comprising, in polymerized form, compound (a1) comprising acrylic acid, methacrylic acid, an acrylic acid oligomer, a methacrylic acid oligomer, an acrylic acid salt, a methacrylic acid salt, an acrylic acid oligomer salt, and/or a methacrylic acid oligomer salt, the polymerization of the water-soluble polymer P1 comprising an initiator;
a binding agent R comprising a water-soluble polymer P2, with a molecular mass Mw, measured by SEC, in a range of from 2,000 to less than 100,000 g/mol, comprising, in polymerized form, compound (a2) acrylic acid, methacrylic acid, an acrylic acid oligomer, a methacrylic acid oligomer, an acrylic acid salt, a methacrylic acid salt, an acrylic acid oligomer salt, and/or a methacrylic acid oligomer salt, the polymerization of the water-soluble polymer P2 comprising an initiator; and
a material E comprising carbon particles; then
applying the electroactive composition;
drying then calendering the metallic substrate carrying the primer coating and the electroactive coating,
wherein the metallic cathode substrate comprises aluminum and/or nickel, and
wherein the electroactive composition comprises an electroactive compound, a binding compound of the electroactive compound, and an organic solvent.

17. The method of claim 1, wherein the water-soluble polymer P1 is a copolymer and comprises, in polymerized form, the compound (a1) and a second compound (b) comprising
(b1) a C₁-C₁₂ methacrylic acid ester and/or a C₁-C₁₂ acrylic acid ester,
(b2) acrylonitrile, acrylamide, N-methylolacrylamide, vinyl lactam, N-vinylpyrrolidone, and/or ureido methacrylate,
(b3) maleic acid, maleic anhydride, itaconic acid, and/or crotonic acid,
(b4) hydroxyethyl acrylate, hydroxyethyl methacrylate, hydroxypropyl acrylate, hydroxypropyl methacrylate, hydroxybutyl methacrylate, caprolactone methacrylate, caprolactone acrylate, polycaprolactone methacrylate, polycaprolactone acrylate, lactam methacrylate, lactam acrylate, polycaprolactam methacrylate, polycaprolactam acrylate, and/or styrene,
(b5) 2-acrylamido-2-methylpropane sulfonic acid, a 2-acrylamido-2-methylpropane sulfonic acid salt, ethoxy methacrylate sulfonic acid, sodium methallyl sulfonate, styrene sulfonate, hydroxyethyl acrylate phosphate, hydroxyethyl methacrylate phosphate, hydroxypropyl acrylate phosphate, hydroxypropyl methacrylate phosphate, and/or hydroxybutyl methacrylate phosphate, and/or
(b6) a cross-linking compound.

18. The method of claim 1, wherein the water-soluble polymer P2 is a copolymer of the compound (a2) and a third compound (c) comprising
(c1) a C₁-C₁₂ methacrylic acid ester and/or a C₁-C₁₂ acrylic acid ester,
(c2) acrylonitrile, acrylamide, N-methylolacrylamide, vinyl lactam, N-vinylpyrrolidone, and/or ureido methacrylate,
(c3) maleic acid, maleic anhydride, itaconic acid, and/or crotonic acid,
(c4) hydroxyethyl acrylate, hydroxyethyl methacrylate, hydroxypropyl acrylate, hydroxypropyl methacrylate, hydroxybutyl methacrylate, caprolactone methacrylate, caprolactone acrylate, polycaprolactone methacrylate, polycaprolactone acrylate, lactam methacrylate, lactam acrylate, polycaprolactam methacrylate, polycaprolactam acrylate, and/or styrene,
(b5) 2-acrylamido-2-methylpropane sulfonic acid, a 2-acrylamido-2-methylpropane sulfonic acid salt, ethoxy methacrylate sulfonic acid, sodium methallyl sulfonate, styrene sulfonate, hydroxyethyl acrylate phosphate, hydroxyethyl methacrylate phosphate, hydroxypropyl acrylate phosphate, hydroxypropyl methacrylate phosphate, and/or hydroxybutyl methacrylate phosphate, and/or
(c6) a cross-linking compound.

19. The method of claim 1, further comprising:
calendering a metallic substrate comprising the primer coating, or
simultaneously applying the binding agent Q and material E and separately applying the agent R.
